(19) United States
(12) Patent Application Publication
(10) Pub. No.: US 2004/0155966 A1
(43) Pub. Date: Aug. 12, 2004

(54) Digital camera having USB drive and method of feeding power to USB drive

(75) Inventors: Won-Kyu Jang, Seongnam-si (KR); Byoung-Kyu Lee, Seongnam-si (KR)

Correspondence Address: GARDNER CARTON & DOUGLAS LLP, ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/774,557

(22) Filed: Feb. 9, 2004

(30) Foreign Application Priority Data
Feb. 10, 2003 (KR) 2003-8142

(51) Int. Cl. H04N 5/225

(52) U.S. Cl. 348/207.1

(57) ABSTRACT

A digital camera contains a camera main body that obtains data of an object to be photographed and a USB drive that receives the data from the camera main body, stores the data, and transmits the stored data directly to a computer main body independent of the camera main body. The invention also provides a method of feeding power to the USB drive in order for the USB drive to receive data from the camera main body, store the received data, and transmit the data to a computer main body independent of the camera main body. The method further includes a means for recognizing the installation of the USB drive, cutting off the power fed to the USB drive if the USB drive is not installed, transmitting the data to the USB drive if the USB drive is installed, and cutting off the power fed to the USB drive when the transmission of the data is complete.

This application claims priority to Korean Patent Application No. 2003-8142, filed on Feb. 10, 2003, in the Korean Intellectual Property Office, the disclosure of which is incorporated herein in its entirety by reference.

1. Field of the Invention

The present invention relates to a digital camera, and more particularly, to a digital camera having a universal serial bus (USB) drive as a storage device of image data, and a method of feeding power to the USB drive.

2. Background of the Invention

In general, digital cameras include an internal memory or a memory card for an external memory to store image data of an object being photographed. The internal memory is mainly used for a low resolution camera due to its relatively small storing capacity whereas the external memory card is typically used for a high resolution camera. Securing a space for the installation of a connector of the external memory card in the digital camera has been problematic.

To transmit image data from the digital camera to a computer, the camera and the computer are connected by a wire or wireless connection. An additional card reader is needed when the image data is to be transmitted without using the main body of the digital camera. That is, the image data stored on the memory card of the digital camera cannot be transmitted to the computer without the main body of the camera or a card reader. Therefore, it is quite inconvenient to use the external memory card as a storage device for image data of a digital camera.

### SUMMARY OF THE INVENTION

To solve the above problem, the present invention provides a digital camera having a universal serial bus (USB) drive that is used as a storage device to store image data, and a method of feeding power to the USB drive.

According to an embodiment of the present invention, a digital camera contains a main body to obtain data of an object and a USB drive to receive the data, store the data, and transmit the stored data directly to a computer main body independent of the camera main body.

The camera main body has a USB port at one side thereof, and the USB drive has a USB plug at one end portion thereof to be detachably coupled to the USB port. The USB plug is rotatable to be either parallel to or perpendicular to the lengthwise direction of the USB drive.

Another embodiment of the present invention is directed to a method of delivering power to a USB drive of a digital camera so that the USB drive can receive data from a camera main body and store the received data. The method includes feeding power to the USB drive of the digital camera, recognizing installation of the USB drive after the power is fed, cutting off the power to the USB drive if the USB drive is not installed, transmitting the data to the USB drive if the USB drive is installed, cutting off the power to the USB drive when the transmission of the data is completed, and repeating all the above operations in a sequential order. The power of the USB drive may be fed from the camera main body.

A further embodiment of the present invention is directed to a means for delivering power to a USB drive of a digital camera that includes a means for recognizing whether a USB drive has been installed in the digital camera after power has been delivered to the USB drive, a means for discontinuing the power to the USB drive if the USB drive is not installed, a means for transmitting data to the USB drive if the USB drive is installed in the digital camera, and means for discontinuing the power to the USB drive when data has been transmitted completely.

### BRIEF DESCRIPTION OF THE DRAWINGS

The above and other features and advantages of the present invention will become more apparent by describing in detail preferred embodiments thereof with reference to the attached drawings in which:

FIG. 1 is a perspective view illustrating a digital camera according to a preferred embodiment of the present invention;

FIG. 2 is a rear view illustrating the digital camera of FIG. 1;

FIG. 3 is a block diagram illustrating the USB drive shown in FIGS. 1 and 2;

FIG. 4 is a reference view illustrating the connection between the USB drive and the computer main body shown in FIGS. 1 and 2;

FIG. 5 is a flow chart for explaining a method of feeding power to the USB drive according to a preferred embodiment of the present invention;

FIG. 6 is a view illustrating a method of recognizing the installation of the USB drive in Step S20 of FIG. 5; and

FIG. 7 is a timing diagram for explaining the relationship between the power feeding to the USB drive and the transmission of image data shown in FIG. 5.

### DETAILED DESCRIPTION OF THE INVENTION

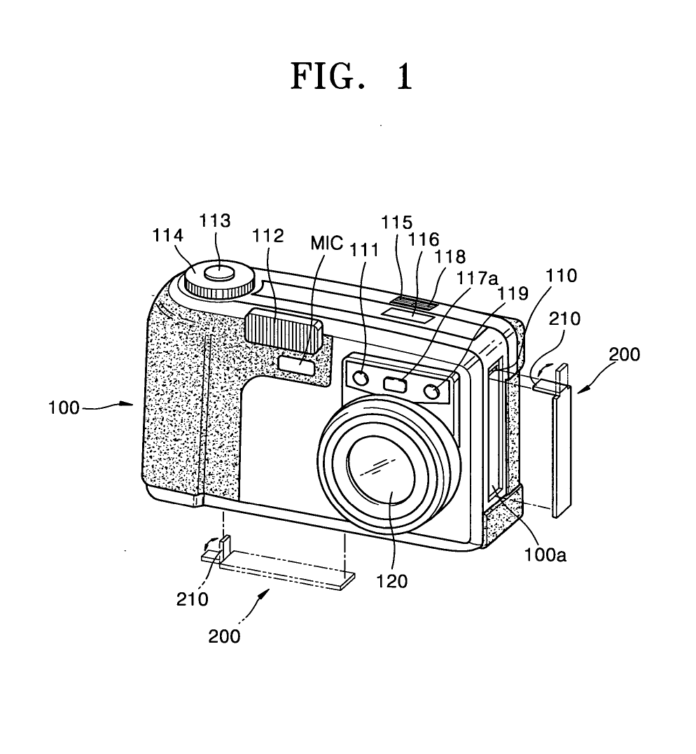

FIGS. 1, 2, and 3 illustrate a digital camera according to a preferred embodiment of the present invention which includes a camera main body 100 and a USB drive 200 as a storage device to store image data received from the camera main body 100. The USB drive 200 receives data from the camera main body 100 and transmits the stored image data directly to a computer main body 300 independent of the camera main body 100.

As shown in FIG. 1, a microphone MIC, a self-timer lamp 111, a flash 112, a shutter button 113, a mode dial 114, a function selection button 115, a photographing information display portion 116, a viewfinder 117a, a function block button 118, a flash light amount sensor 119, and a lens portion 120 are provided on the front side of the camera main body 100.

The self-timer lamp 111 flickers in a self-timer mode during a set time after the shutter button 113 is pressed until the photographing starts. The mode dial 114 is used for a user to set a variety of modes The modes include, but are not limited to a still image photographing mode, a night view photographing mode, a motion picture photographing mode, a reproduction mode, a computer connection mode, and a system setting mode. The function selection button 115 is used for the user to select one of the operational modes of the camera main body 100, for example, the still image photographing mode, the night view photographing mode, the motion picture photographing mode, and the reproduction mode. The photographing information display portion 116 displays information of the respective functions related to photographing.

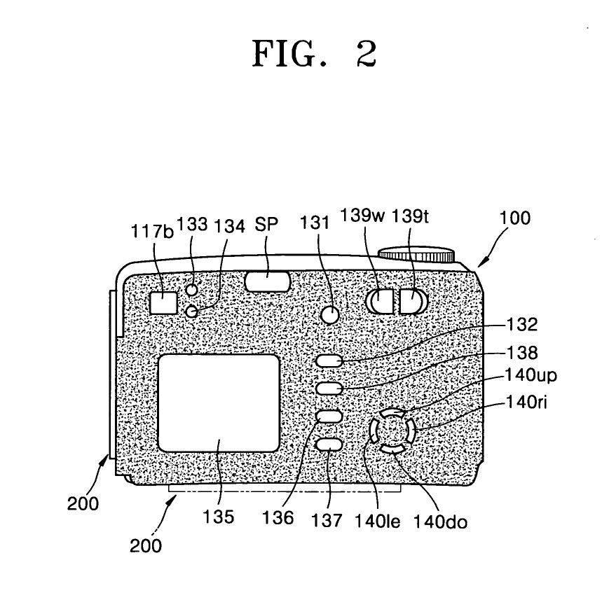

As shown in FIG. 2, a speaker SP, a power button 131, a monitor button 132, an auto-focus lamp 133, a viewfinder 117b, a flash ready lamp 134, a display panel 135, a confirm/delete button 136, an enter/play button 137, a menu button 138, a wide angle zoom button 139w, a telephoto zoom button 139t, an up movement button 140up, a right movement button 140ri, a down movement button 140do, and a left movement button 140le are arranged on the rear side of the camera main body 100.

The monitor button 132 is used to control the operation of the display panel 135. For example, when the monitor button 132 is initially pressed, an image of the object to be photographed and the photographing information are displayed on the display panel 135. When the monitor button 132 is pressed again, only the image of the object to be photographed is displayed on the display panel 135. When the monitor button 132 is pressed a third time, the power that was applied to the display panel 135 is cut off. The auto-focus lamp 133 operates when an input image is well focused. The flash ready lamp 134 operates when the flash 112 of FIG. 1 is in a ready mode. The confirm/delete button 136 is used as a confirmation button or a delete button in the process in which the user sets each mode. The enter/play button 137 is used by the user to input data, stop the input of data or reproduce data when in the reproduction mode. The menu button 138 is used to display the menu of the mode selected by the mode dial 114 of FIG. 1. The up movement button 140up, the right movement button 140ri, the down movement button 140do, and the left movement button 140le are used by the user to set each mode.

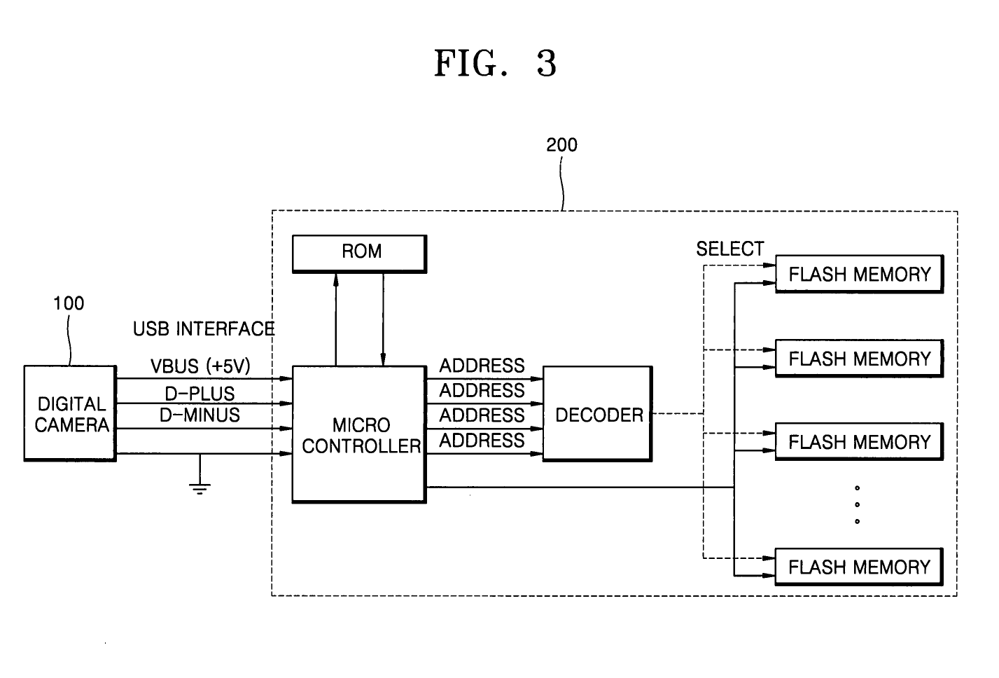

FIG. 3 is a block diagram illustrating a USB drive 200 which is disclosed in Korean Patent Application No. 2000-0070177. As shown in FIG. 3, the USB drive 200 includes a microcontroller connected to the camera main body 100. The microcontroller receives data through a D-plus and D-minus connection. The microcontroller also transmits and receives data from a ROM storing firmware. The USB drive 200 also includes a decoder that receives an address from the microcontroller and decodes the received address into a flash memory selection signal. The USB drive 200 contains a plurality of flash memories connected to the decoder for storing data.

To connect the USB drive 200 and the camera main body 100, the camera main body 100 includes a USB port 110 at one side thereof. A USB plug 210, provided at one end of the USB drive 200, is detachably coupled to the USB port 110. The USB drive 200 can be installed at the lower portion of the camera main body 100 as shown in FIGS. 1 and 2.

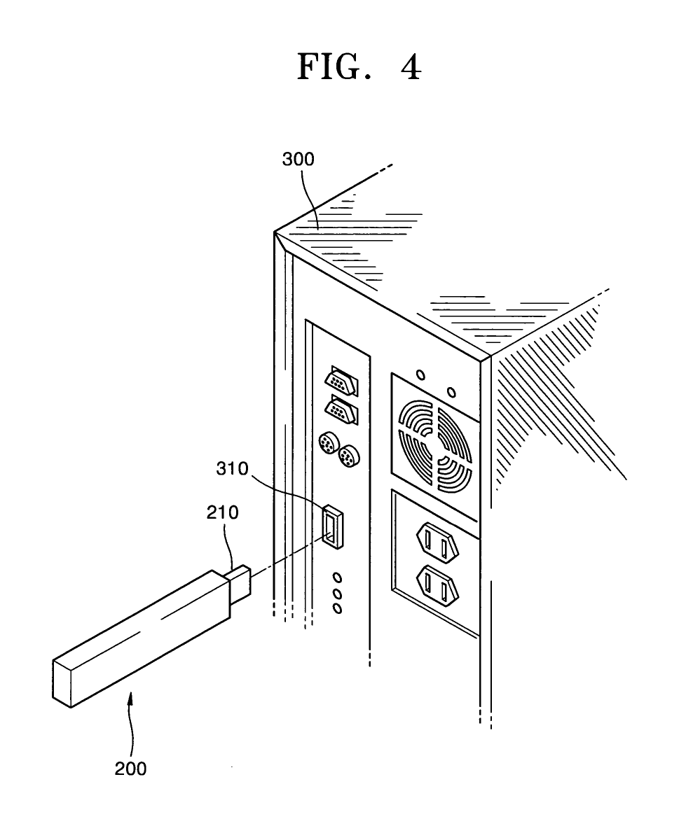

The USB plug 210 is rotatable to be either parallel to or perpendicular to the lengthwise direction of the USB drive 200. Thus, when the USB drive 200 is connected to the camera main body 100, the USB drive 210 is coupled to the USB port 110 while being rotated perpendicular to a lengthwise direction of the USB drive 200. As shown in FIG. 4, when the stored data is to be directly transmitted to the computer main body 300, the USB plug 210 is directly coupled to the USB port 310 of the computer main body 300 while being rotated parallel to the lengthwise direction of the USB drive 200. The USB drive 200 can transmit the data directly to the computer main body 300 by installing a device drive only, without additional application software or material.

A method of feeding power to the USB drive 200 is described below with reference to the accompanying drawings.

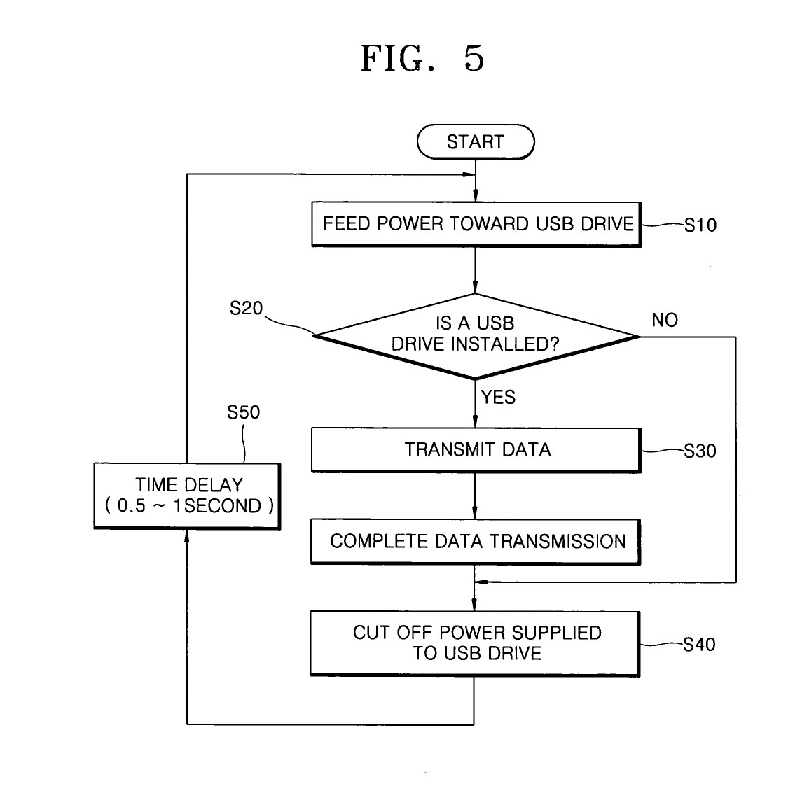

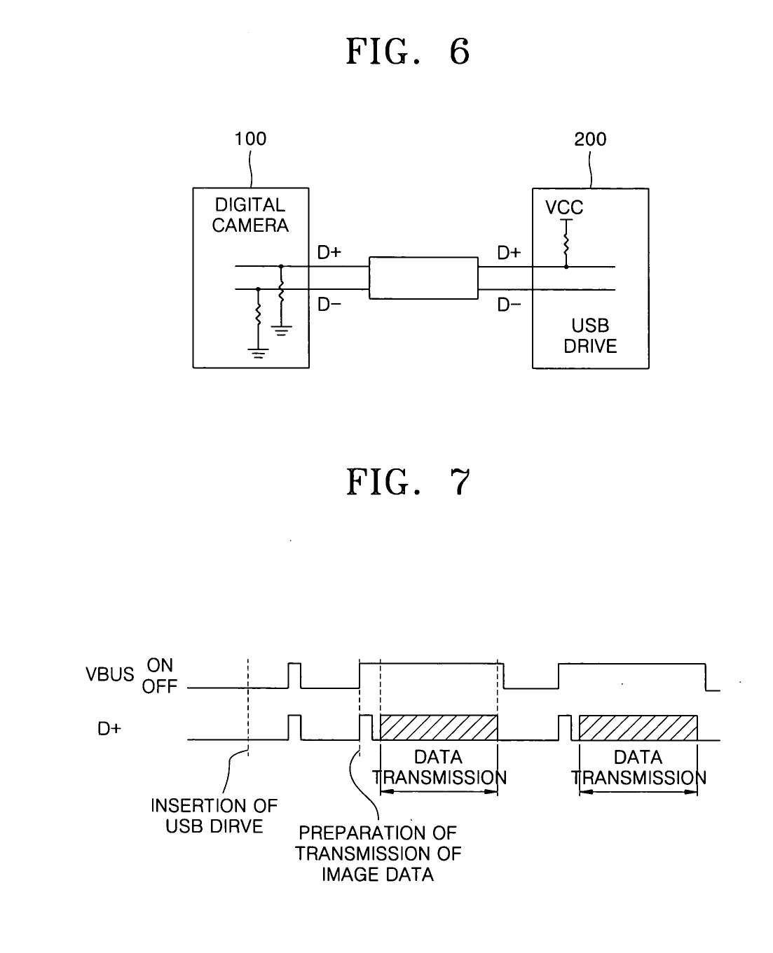

FIG. 5 is a flow chart for explaining a method of feeding power to the USB drive according to a preferred embodiment of the present invention. FIG. 6 is a view illustrating a method of recognizing the installation of the USB drive in Step S20 of FIG. 5.

First, as shown in FIGS. 3 and 5, power is fed from the camera main body 100 toward the USB drive 200 (S10). Since the camera main body 100 needs to be a host, the power must be fed from the camera main body 100 toward the USB drive 200. For this purpose, a 5V power line is supplied.

Next, in order for the camera main body 100 to be a host, whether the USB drive 200 is installed is automatically recognized (S20). The installation of the USB drive 200 can be recognized in the following method. As shown in FIG. 6, by connecting a pull-up resistor to the D-plus of the USB drive 200, a voltage is generated in the D-minus when the USB drive 200 is installed. Thus, when voltage is detected in the D-plus, the installation of the USB drive 200 in the camera main body 100 is recognized.

However, continuously feeding the voltage to the USB drive 200 is inefficient. Thus; when it is recognized that the USB drive 200 is not installed, the power from the camera main body 100 toward the USB drive 200 is discontinued. If it is recognized that the USB drive 200 is installed, then the data is transmitted (S30). When the transmission of data is completed, the power from the camera main body 100 toward the USB drive 200 is discontinued (S40). Therefore, power is fed between the camera main body 100 and the USB drive 200 only when data is transmitted.

The present invention also includes a means for checking whether the USB drive 200 is installed even when data transmission is not generated. Accordingly, after a delay time of about 0.5 to 1 second (S50), power is fed toward the USB drive 200 to determine whether voltage is detected in the D-plus, thereby periodically checking the installation of the USB drive 200. In other words, after a certain delay time (S50), the above steps S10-S40 are sequentially repeated.

FIG. 7 is a timing diagram for explaining the relationship between the power to the USB drive and the transmission of image data shown in FIG. 5. As shown in FIG. 7, when data is not transmitted, 5V is periodically applied to VBUS to check whether a voltage is detected in the D-plus. Thus, the installation of the USB drive is confirmed so that the data is transmitted. When the transmission of the data is completed, the power supplied to VBUS is cut off so that power is not wasted.

As described above, the digital camera having a USB drive and the method of feeding power to the USB drive of the digital camera according to the present invention have the following effects.

First, since a USB port for the USB drive is provided in the camera main body without a connection of a memory card, the inner space of the camera main body is reduced so that a compact digital camera can be manufactured.

Second, since the USB drive is recognized as a removable disk when it is connected to the USB port of the computer main body without a card reader, data can be transmitted to the computer main body with the USB drive without the need for other additional devices.

Third, since the USB plug of the USB drive is capable of rotating, the USB drive can be easily connected not only to the camera main body but also to the computer main body.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A digital camera comprising:
a camera main body that obtains data of an object to be photographed by the digital camera; and
a USB drive that receives the data from the camera main body, stores the data, and transmits the stored data directly to a computer main body independent of the camera main body.

2. The digital camera of claim 1, wherein the camera main body has a USB port at one side thereof and the USB drive has a USB plug at one end portion thereof to be detachably coupled to the USB port.

3. The digital camera of claim 2, wherein the USB plug is rotatable to be parallel to a lengthwise direction of the USB drive.

4. The digital camera of claim 2, wherein the USB plug is rotatable to be perpendicular to a lengthwise direction of the USB drive.

5. A method of delivering power to a USB drive of a digital camera comprising:
(a) supplying power to the USB drive;
(b) recognizing installation of the USB drive after the power is fed to the USB drive;
(c) cutting off the power supplied to the USB drive if the USB drive is not installed;
(d) transmitting data from a main body of the digital camera to the USB drive if the USB drive is installed; and
(e) cutting off the power supplied to the USB drive when transmission of the data is completed.

6. The method of claim 5 wherein the steps (a), (b), (c), (d), and (e) are performed in sequential order.

7. The method of claim 5 wherein the power is supplied to the USB drive from the main body of the digital camera.

8. A means for delivering power to a USB drive of a digital camera comprising:
(a) a means for recognizing whether a USB drive has been installed in the digital camera after power has been delivered to the USB drive;
(b) a means for discontinuing the power to the USB drive if the USB drive is not installed;
(c) a means for transmitting data to the USB drive if the USB drive is installed in the digital camera; and
(d) a means for discontinuing the power to the USB drive when data has been transmitted completely.
